(19) United States
(12) Patent Application Publication
(10) Pub. No.: US 2023/0023684 A1
(43) Pub. Date: Jan. 26, 2023

(54) METHOD OF STAIN REMOVAL USING BACTERIAL SPORES

(71) Applicant: The Procter & Gamble Company, Cincinnati, OH (US)

(72) Inventors: Neil Joseph LANT, NEWCASTLE UPON TYNE (GB); Katherine Esther Latimer, NEWCASTLE UPON TYNE (GB); Samuel Kimani Njoroge, Montgomery, OH (US); Kathleen Kirkwood, Newcastle upon Tyne (GB)

(21) Appl. No.: 17/829,410

(22) Filed: Jun. 1, 2022

(30) Foreign Application Priority Data
Jul. 19, 2021 (EP) 21186296.6

(51) Int. Cl. C11D 3/38; C11D 11/00; C11D 3/386; C11D 17/00

(52) U.S. Cl. CPC C11D 3/381; C11D 11/0017; C11D 3/386; C11D 17/0043

(57) ABSTRACT

A method of facilitating stain removal from a fabric including treating the fabric directly with bacterial spores prior to a laundry process; and subsequently subjecting the fabric to a laundry process.

### FIELD OF THE INVENTION

The present application is in the field of cleaning, it relates to a method of facilitating the removal of enzymatic stains from a fabric using bacterial spores. The present application also relates to the use of bacterial spores to provide second time cleaning benefits.

### BACKGROUND OF THE INVENTION

Formulators are constantly looking to facilitate the cleaning of soiled surfaces. The removal of certain stains, particularly enzymatic stains from fabrics can be challenging, in particular with current trends to use less aggressive formulations and more environmentally friendly washing cycles, involving lower temperatures, shorter cycles and lower amounts of water.

Thus, there is still the need to provide a process that makes easier the removal of soils from surfaces, especially the removal of enzymatic stains from fabrics.

### SUMMARY OF THE INVENTION

According to a first aspect, there is provided a method of facilitating the removal of stains from a fabric, the method comprising the step of treating a stained fabric with bacterial spores, preferably Bacillus spores, prior to a laundry process.

According to a second aspect, there is provided the use of bacterial spores, preferably Bacillus spores to provide stain removal benefits from surfaces during a subsequent cleaning process. The use of the invention facilitates the removal of enzymatic stains from surfaces by treating the surface with bacterial spores prior to the cleaning process.

The elements of the first aspect apply mutatis mutandis to the second aspect.

### DETAILED DESCRIPTION OF THE INVENTION

The present invention encompasses the use of bacterial spores, preferably Bacillus spores. Preferably, the Bacillus is selected from the group consisting of Bacillus subtilis, Bacillus amyloliquefaciens, Bacillus licheniformis, Bacillus megaterium, Bacillus pumilus, Bacillus cereus, Bacillus thuringiensis, Bacillus mycoides, Bacillus tequilensis, Bacillus vallismortis, Bacillus mojavensis and mixtures thereof, more preferably the Bacillus is selected from the group consisting of Bacillus subtilis, Bacillus amyloliquefaciens, Bacillus licheniformis, Bacillus megaterium, Bacillus pumilus and mixtures thereof.

The spores are used to facilitate stain removal from surfaces during a subsequent cleaning process. After a surface has been treated with bacterial spores, stains deposited on that surface are more easily removed than without previous treatment. This effect is generally referred to as “next time cleaning benefit”. The effect is especially noticeable on enzymatic stains, stains comprising a carbohydrate and/or a protein and/or a fat. The spores facilitate the removal of stains comprising a carbohydrate, preferably a sugar, and a protein and a fat. For example stains comprising at least 20% carbohydrate and/or at least 20% fat and at least 0.5% protein. The use of the invention is particularly effective for the removal from fabrics of stains comprising a carbohydrate, preferably a sugar, and/or a protein and/or a fat, for example chocolate milk stains.

The present invention also encompasses a method to facilitate the removal of enzymatic stains from a fabric using bacterial spores, preferably Bacillus spores, prior to the cleaning of the fabric. The use of the invention can be applied to hard and soft surfaces. Hard surface includes any household surface such as surfaces found in kitchen and bathrooms, including cooker tops, extractor fans, tiles, floors, work surfaces, etc. The use of the invention is particularly suited for the removal of enzymatic stains from soft surfaces, particularly from fabrics subjected to a laundry process. The use and method of the invention allow for the use of gentle cleaning products and environmentally friendly cleaning cycles.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

All percentages, ratios and proportions used herein are by weight percent of the composition, unless otherwise specified. All average values are calculated “by weight” of the composition, unless otherwise expressly indicated. All ratios are calculated as a weight/weight level, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Form of Utilization

The invention provides the use of bacterial spores, preferably Bacillus spores for facilitating the removal of stains, preferably enzymatic stains from surfaces, wherein the surface is treated with the bacterial spores prior to a cleaning process. Preferably, the bacterial spores are applied to the surface as a solution, preferably an aqueous solution, that might thereafter be left to dry on the surface. Preferably the stain comprises carbohydrates and/or are rich on fat and additionally comprises proteins. Preferably, the dry stain comprises at least 20% carbohydrate and/or 20% fat and at least 0.5% protein.

Bacterial spores may be applied to the surface from an additive composition. Preferably the bacterial spores are applied to the surface from an aqueous solution. The bacterial spores can be applied in the form of a spray, before a laundry process.

### Method of Treating a Surface

The present disclosure relates to a method of facilitating the removal of enzymatic stains from a fabric, the method comprises the step of treating the fabric with bacterial spores, preferably Bacillus spores, prior to a laundry process.

The method of the present disclosure includes contacting a fabric with a product comprising bacterial spores, prior to the laundry process. The contacting may occur in the presence or absence of water. The product, or part thereof, may be diluted and/or dissolved in water to form a treatment liquor, or the product might be a ready to use spray.

In an embodiment the fabric is stored for at least 15 minutes, preferably at least 30 minutes before subjecting it to the laundry process. For example, the stained fabric can be treated before putting it in the laundry basket.

The method of the present disclosure might include contacting the fabric with an aqueous treatment liquor. The aqueous treatment liquor may comprise from about 0.001 ppm, or from about 0.01 ppm, or from about 0.02 ppm, or from about 0.05 ppm, or from about 0.1 ppm, to about 1 ppm, or to about 5 ppm, or to about 10 ppm, or to about 100 ppm, of total bacterial spores, preferably Bacillus spores.

The laundry process of the method of the present disclosure may take place partially in any suitable vessel, for example it may take place in an automatic washing machine. Such machines may be top-loading machines or front-loading machines. The method of the invention is also suitable for hand washing applications.

The laundry process of the method of the present disclosure may include contacting the fabric with an aqueous wash liquor. The aqueous wash liquor may comprise a cleaning composition, such as a granular or liquid laundry detergent composition, that is dissolved or diluted in water. The detergent composition may include anionic surfactant. The aqueous wash liquor may comprise from about 50 to about 5000 ppm, or from about 100 to about 1000 ppm, anionic surfactant.

The laundry process might comprise a wash, a rinse and a drying cycle. The bacterial spores are delivered prior to the laundry process. They can be delivered to the fabric from a cleaning composition and/or from an additive composition, preferably, they are delivered from an additive composition, more preferably from a ready to use spray. The bacterial spores, preferably Bacillus spores may be added from an additive composition in a level of from about 0.01% to about 5% by weight of the fabric. The fabric treated may be a natural or a synthetic fabric. Suitable synthetic fabrics include polyester, acrylic, nylon, rayon, acetate, spandex, latex, and/or orlon fabrics.

The fabric treated may include synthetic fibers. Suitable synthetic fibers may include polyester, acrylic, nylon, rayon, acetate, spandex, latex, and/or orlon fibers. The fibers may be elastic and/or contain elastane. The fabric may contain blends of synthetic fibers and natural fibers (e.g., a polycotton blend). The fabric may comprise fibers that are relatively hydrophobic (for example, compared to cotton fibers).

### Bacterial Spores

Although bacterial spores can be present on surfaces, the use and method of the invention involves the intentional addition of bacterial spores to the surface in an amount capable of providing a consumer noticeable next time cleaning benefit. Preferably, the use and the method of the invention requires the intentional addition of at least 1×10² CFU/g of surface, preferably from about 1×10² to 1×10⁴ CFU/g of surface, when the bacterial spores are delivered through a process involving an aqueous liquor such as a laundry process. Preferably, the use and the method of the invention requires the intentional addition of at least 1×10³ CFU/g of surface, preferably at least 1×10⁴ CFU/g of surface, to 1×10⁶ CFU/g of surface when the bacterial spores are delivered by direct application, for example by spraying directly on the surface. By “intentional addition of bacterial spores” is herein meant that the spores are added in addition to the microorganisms that might be present on the surface.

The bacterial spores are fabric-substantive. The bacterial spores of the use and method of the invention can germinate on fabrics. The spores can be activated by heat, for example, heat generated during use of the fabric or by the heat provided in the washing machine or in the dryer. The spores can germinate when the fabrics are stored and/or used. Malodor precursors can be used by the bacteria produced by the spores as nutrients promoting germination. Spores can germinate after the fabrics are left in the humid environment.

The bacterial spores for use herein have the ability to germinate between cleaning processes; and have the ability to provide second time cleaning benefits. The spores have the ability to germinate and to form cells before the fabric is subjected to the laundry process. The spores can be delivered in liquid or solid form. Preferably, the spores are in solid form. The spores can be delivered into the drying process from a reservoir, a dryer ball, a solid carrier, such as a pouch, pellet, beads, a tablet, a dryer sheet, etc. Preferably the pellets are substantially spherical and/or cylindrical and have a diameter of from about 1 mm to about 30 mm. The spores may be delivered from a dryer sheet.

The bacterial spores can be delivered to the surface as part of any suitable product, such as a ready to use spray or laundry pre-treater.

The product comprising the bacterial spores can be in any suitable form. It may be in the form of a liquid composition, a granular composition, a single-compartment pouch, a multi-compartment pouch, a sheet, a pastille or bead, a fibrous article, a tablet, a bar, flake, or a mixture thereof. The product can be selected from a liquid, solid, or combination thereof.

The product comprising the bacterial spores may be a liquid composition. The composition may include from about 30% to about 90%, or from about 50% to about 80%, by weight of the composition, of water.

The product comprising the bacterial spores may be a cleaning or additive composition, it may be in the form of a unitized dose article, such as a tablet, a pouch, a sheet, or a fibrous article. Such pouches typically include a water-soluble film, such as a polyvinyl alcohol water-soluble film, that at least partially encapsulates a composition. Suitable films are available from MonoSol, LLC (Indiana, USA). The procut can be encapsulated in a single or multi-compartment pouch. A multi-compartment pouch may have at least two, at least three, or at least four compartments. A multi-compartmented pouch may include compartments that are side-by-side and/or superposed. The composition contained in the pouch or compartments thereof may be liquid, solid (such as powders), or combinations thereof. Pouched compositions may have relatively low amounts of water, for example less than about 20%, or less than about 15%, or less than about 12%, or less than about 10%, or less than about 8%, by weight of the detergent composition, of water.

The product comprising the bacterial spores may be in the form of a pastille or bead. The pastille may include polyethylene glycol as a carrier. The polyethylene glycol may have a weight average molecular weight of from about 2000 to about 20,000 Daltons, preferably from about 5000 to about 15,000 Daltons, more preferably from about 6000 to about 12,000 Daltons. Preferably, the pastille comprises bacterial spores.

The product comprising the bacterial spores may comprise a non-aqueous solvent, which may act as a carrier and/or facilitate stability. Non-aqueous solvents may include organic solvents, such as methanol, ethanol, propanol, isopropanol, 1,3-propanediol, 1,2-propanediol, ethylene glycol, glycerine, glycol ethers, hydrocarbons, or mixtures thereof. Other non-aqueous solvents may include lipophilic fluids such as siloxanes or other silicones, hydrocarbons, perfluorinated amines, perfluorinated and hydrofluoroether solvents, or mixtures thereof. Amine-containing solvents, such as monoethanolamine, diethanolamine and triethanolamine, may be suitable.

Some gram-positive bacteria have a two-stage lifecycle in which growing bacteria under certain conditions such as in response to nutritional deprivation can undergo an elaborate developmental program leading to spores or endospores formation. The bacterial spores are protected by a coat consisting of about 60 different proteins assembled as a biochemically complex structure with intriguing morphological and mechanical properties. The protein coat is considered a static structure that provides rigidity and mainly acting as a sieve to exclude exogenous large toxic molecules, such as lytic enzymes. Spores play critical roles in long term survival of the species because they are highly resistant to extreme environmental conditions. Spores are also capable of remaining metabolically dormant for years. Methods for obtaining bacterial spores from vegetative cells are well known in the field. In some examples, vegetative bacterial cells are grown in liquid medium. Beginning in the late logarithmic growth phase or early stationary growth phase, the bacteria may begin to sporulate. When the bacteria have finished sporulating, the spores may be obtained from the medium, by using centrifugation for example. Various methods may be used to kill or remove any remaining vegetative cells. Various methods may be used to purify the spores from cellular debris and/or other materials or substances. Bacterial spores may be differentiated from vegetative cells using a variety of techniques, like phase-contrast microscopy, automated scanning microscopy, high resolution atomic force microscopy or tolerance to heat, for example. Because bacterial spores are generally environmentally-tolerant structures that are metabolically inert or dormant, they are readily chosen to be used in commercial microbial products. Despite their ruggedness and extreme longevity, spores can rapidly respond to the presence of small specific molecules known as germinants that signal favorable conditions for breaking dormancy through germination, an initial step in the process of completing the lifecycle by returning to vegetative bacteria. For example, the commercial microbial products may be designed to be dispersed into an environment where the spores encounter the germinants present in the environment to germinate into vegetative cells and perform an intended function. A variety of different bacteria may form spores. Bacteria from any of these groups may be used in the compositions, methods, and kits disclosed herein. For example, some bacteria of the following genera may form spores: Acetonema, Alkalibacillus, Ammoniphilus, Amphibacillus, Anaerobacter, Anaerospora, Aneurinibacillus, Anoxybacillus, Bacillus, Brevibacillus, Caldanaerobacter, Caloramator, Caminicella, Cerasibacillus, Clostridium, Clostridiisalibacter, Cohnella, Dendrosporobacter, Desulfotomaculum, Desulfosporomusa, Desulfosporosinus, Desulfovirgula, Desulfunispora, Desulfurispora, Filifactor, Filobacillus, Gelria, Geobacillus, Geosporobacter, Gracilibacillus, Halonatronum, Heliobacterium, Heliophilum, Laceyella, Lentibacillus, Lysinibacillus, Mahella, Metabacterium, Moorella, Natroniella, Oceanobacillus, Orenia, Ornithinibacillus, Oxalophagus, Oxobacter, Paenibacillus, Paraliobacillus, Pelospora, Pelotomaculum, Piscibacillus, Planfilum, Pontibacillus, Propionispora, Salinibacillus, Salsuginibacillus, Seinonella, Shimazuella, Sporacetigenium, Sporoanaerobacter, Sporobacter, Sporobacterium, Sporohalobacter, Sporolactobacillus, Sporomusa, Sporosarcina, Sporotalea, Sporotomaculum, Syntrophomonas, Syntrophospora, Tenuibacillus, Tepidibacter, Terribacillus, Thalassobacillus, Thermoacetogenium, Thermoactinomyces, Thermoalkalibacillus, Thermoanaerobacter, Thermoanaeromonas, Thermobacillus, Thermoflavimicrobium, Thermovenabulum, Tuberibacillus, Virgibacillus, and/or Vulcanobacillus.

Preferably, the bacteria that may form spores are from the family Bacillaceae, such as species of the genera Aeribacillus, Aliibacillus, Alkalibacillus, Alkalicoccus, Alkalihalobacillus, Alkalilactibacillus, Allobacillus, Alteribacillus, Alteribacter, Amphibacillus, Anaerobacillus, Anoxybacillus, Aquibacillus, Aquisalibacillus, Aureibacillus, Bacillus, Caldalkalibacillus, Caldibacillus, Calditerricola, Calidifontibacillus, Camelliibacillus, Cerasibacillus, Compostibacillus, Cytobacillus, Desertibacillus, Domibacillus, Ectobacillus, Evansella, Falsibacillus, Ferdinandcohnia, Fermentibacillus, Fictibacillus, Filobacillus, Geobacillus, Geomicrobium, Gottfriedia, Gracilibacillus, Halalkalibacillus, Halobacillus, Halolactibacillus, Heyndrickxia, Hydrogenibacillus, Lederbergia, Lentibacillus, Litchfieldia, Lottiidibacillus, Margalitia, Marinococcus, Melghiribacillus, Mesobacillus, Metabacillus, Microaerobacter, Natribacillus, Natronobacillus, Neobacillus, Niallia, Oceanobacillus, Ornithinibacillus, Parageobacillus, Paraliobacillus, Paralkalibacillus, Paucisalibacillus, Pelagirhabdus, Peribacillus, Piscibacillus, Polygonibacillus, Pontibacillus, Pradoshia, Priestia, Pseudogracilibacillus, Pueribacillus, Radiobacillus, Robertmurraya, Rossellomorea, Saccharococcus, Salibacterium, Salimicrobium, Salinibacillus, Salipaludibacillus, Salirhabdus, Salisediminibacterium, Saliterribacillus, Salsuginibacillus, Sediminibacillus, Siminovitchia, Sinibacillus, Sinobaca, Streptohalobacillus, Sutcliffiella, Swionibacillus, Tenuibacillus, Tepidibacillus, Terribacillus, Terrilactibacillus, Texcoconibacillus, Thalassobacillus, Thalassorhabdus, Thermolongibacillus, Virgibacillus, Viridibacillu, Vulcanibacillus, Weizmannia. In various examples, the bacteria may be strains of Bacillus Bacillus acidicola, Bacillus aeolius, Bacillus aerius, Bacillus aerophilus, Bacillus albus, Bacillus altitudinis, Bacillus alveayuensis, Bacillus amyloliquefaciensex, Bacillus anthracis, Bacillus aquiflavi, Bacillus atrophaeus, Bacillus australimaris, Bacillus badius, Bacillus benzoevorans, Bacillus cabrialesii, Bacillus canaveralius, Bacillus capparidis, Bacillus carboniphilus, Bacillus cereus, Bacillus chungangensis, Bacillus coahuilensis, Bacillus cytotoxicus, Bacillus decisifrondis, Bacillus ectoiniformans, Bacillus enclensis, Bacillus fengqiuensis, Bacillus fungorum, Bacillus glycinifermentans, Bacillus gobiensis, Bacillus halotolerans, Bacillus haynesii, Bacillus horti, Bacillus inaquosorum, Bacillus infantis, Bacillus infernus, Bacillus isabeliae, Bacillus kexueae, Bacillus licheniformis, Bacillus luti, Bacillus manusensis, Bacillus marinisedimentorum, Bacillus mesophilus, Bacillus methanolicus, Bacillus mobilis, Bacillus mojavensis, Bacillus mycoides, Bacillus nakamurai, Bacillus ndiopicus, Bacillus nitratireducens, Bacillus oleivorans, Bacillus pacificus, Bacillus pakistanensis, Bacillus paralicheniformis, Bacillus paramycoides, Bacillus paranthracis, Bacillus pervagus, Bacillus piscicola, Bacillus proteolyticus, Bacillus pseudomycoides, Bacillus pumilus, Bacillus safensis, Bacillus salacetis, Bacillus salinus, Bacillus salitolerans, Bacillus seohaeanensis, Bacillus shivajii, Bacillus siamensis, Bacillus smithii, Bacillus solimangrovi, Bacillus songklensis, Bacillus sonorensis, Bacillus spizizenii, Bacillus spongiae, Bacillus stercoris, Bacillus stratosphericus, Bacillus subtilis, Bacillus swezeyi, Bacillus taeanensis, Bacillus tamaricis, Bacillus tequilensis, Bacillus thermocloacae, Bacillus thermotolerans, Bacillus thuringiensis, Bacillus tianshenii, Bacillus toyonensis, Bacillus tropicus, Bacillus vallismortis, Bacillus velezensis, Bacillus wiedmannii, Bacillus wudalianchiensis, Bacillus xiamenensis, Bacillus xiapuensis, Bacillus zhangzhouensis, or combinations thereof.

In some examples, the bacterial strains that form spores may be strains of Bacillus, including: Bacillus sp. strain SD-6991; Bacillus sp. strain SD-6992; Bacillus sp. strain NRRL B-50606; Bacillus sp. strain NRRL B-50887; Bacillus pumilus strain NRRL B-50016; Bacillus amyloliquefaciens strain NRRL B-50017; Bacillus amyloliquefaciens strain PTA-7792 (previously classified as Bacillus atrophaeus); Bacillus amyloliquefaciens strain PTA-7543 (previously classified as Bacillus atrophaeus); Bacillus amyloliquefaciens strain NRRL B-50018; Bacillus amyloliquefaciens strain PTA-7541; Bacillus amyloliquefaciens strain PTA-7544; Bacillus amyloliquefaciens strain PTA-7545; Bacillus amyloliquefaciens strain PTA-7546; Bacillus subtilis strain PTA-7547; Bacillus amyloliquefaciens strain PTA-7549; Bacillus amyloliquefaciens strain PTA-7793; Bacillus amyloliquefaciens strain PTA-7790; Bacillus amyloliquefaciens strain PTA-7791; Bacillus subtilis strain NRRL B-50136 (also known as DA-33R, ATCC accession No. 55406); Bacillus amyloliquefaciens strain NRRL B-50141; Bacillus amyloliquefaciens strain NRRL B-50399; Bacillus licheniformis strain NRRL B-50014; Bacillus licheniformis strain NRRL B-50015; Bacillus amyloliquefaciens strain NRRL B-50607; Bacillus subtilis strain NRRL B-50147 (also known as 300R); Bacillus amyloliquefaciens strain NRRL B-50150; Bacillus amyloliquefaciens strain NRRL B-50154; Bacillus megaterium PTA-3142; Bacillus amyloliquefaciens strain ATCC accession No. 55405 (also known as 300); Bacillus amyloliquefaciens strain ATCC accession No. 55407 (also known as PMX); Bacillus pumilus NRRL B-50398 (also known as ATCC 700385, PMX-1, and NRRL B-50255); Bacillus cereus ATCC accession No. 700386; Bacillus thuringiensis ATCC accession No. 700387 (all of the above strains are available from Novozymes, Inc., USA); Bacillus amyloliquefaciens FZB24 (e.g., isolates NRRL B-50304 and NRRL B-50349 TAEGRO® from Novozymes), Bacillus subtilis (e.g., isolate NRRL B-21661 in RHAPSODY®, SERENADE® MAX and SERENADE® ASO from Bayer CropScience), Bacillus pumilus (e.g., isolate NRRL B-50349 from Bayer CropScience), Bacillus amyloliquefaciens TrigoCor (also known as “TrigoCor 1448”; e.g., isolate Embrapa Trigo Accession No. 144/88.4Lev, Cornell Accession No. Pma007BR-97, and ATCC accession No. 202152, from Cornell University, USA) and combinations thereof.

In some examples, the bacterial strains that form spores may be strains of Bacillus amyloliquefaciens. For example, the strains may be Bacillus amyloliquefaciens strain PTA-7543 (previously classified as Bacillus atrophaeus), and/or Bacillus amyloliquefaciens strain NRRL B-50154, Bacillus amyloliquefaciens strain PTA-7543 (previously classified as Bacillus atrophaeus), Bacillus amyloliquefaciens strain NRRL B-50154, or from other Bacillus amyloliquefaciens organisms.

In some examples, the bacterial strains that form spores may be Brevibacillus spp., e.g., Brevibacillus brevis; Brevibacillus formosus; Brevibacillus laterosporus; or Brevibacillus parabrevis, or combinations thereof.

In some examples, the bacterial strains that form spores may be Paenibacillus spp., e.g., Paenibacillus alvei; Paenibacillus amylolyticus; Paenibacillus azotofixans; Paenibacillus cookii; Paenibacillus macerans; Paenibacillus polymyxa; Paenibacillus validus, or combinations thereof. The bacterial spores may have an average particle diameter of about 2-50 microns, suitably about 10-45 microns. Bacillus spores are commercially available in blends in aqueous carriers and are insoluble in the aqueous carriers. Other commercially available bacillus spore blends include without limitation Freshen Free™ CAN (10×), available from Novozymes Biologicals, Inc.; Evogen® Renew Plus (10×), available from Genesis Biosciences, Inc.; and Evogen® GT (10×, 20× and 110×), all available from Genesis Biosciences, Inc. In the foregoing list, the parenthetical notations (10×, 20×, and 10×) indicate relative concentrations of the Bacillus spores.

Bacterial spores used in the compositions, methods, and products disclosed herein may or may not be heat activated. In some examples, the bacterial spores are heat activated. In some examples, the bacterial spores are not heat inactivated. Preferably, the spores used herein are heat activated. Heat activation may comprise heating bacterial spores from room temperature (15-25° C.) to optimal temperature of between 25-120° C., preferably between 40 C-100° C., and held the optimal temperature for not more than 2 hours, preferably between 70-80° C. for 30 min.

For the methods, compositions and products disclosed herein, populations of bacterial spores are generally used. In some examples, a population of bacterial spores may include bacterial spores from a single strain of bacterium. Preferably, a population of bacterial spores may include bacterial spores from 2, 3, 4, 5, or more strains of bacteria. Generally, a population of bacterial spores contains a majority of spores and a minority of vegetative cells. In some examples, a population of bacterial spores does not contain vegetative cells. In some examples, a population of bacterial spores may contain less than about 1%, 2%, 3%, 4%, 5%, 6%, 7%, 8%, 9%, 10%, 15%, 20%, 25%, 30%, 40%, or 50% vegetative cells, where the percentage of bacterial spores is calculated as ((vegetative cells/(spores in population+vegetative cells in population))×100). Generally, populations of bacterial spores used in the disclosed methods, compositions and products are stable (i.e. not undergoing germination), with at least some individual spores in the population capable of germinating.

Populations of bacterial spores used in this disclosure may contain bacterial spores at different concentrations. In various examples, populations of bacterial spores may contain, without limitation, at least 1×102, 5×102, 1×103, 5×103, 1×104, 5×104, 1×105, 5×105, 1×106, 5×106, 1×107, 5×107, 1×108, 5×108, 1×109, 5×109, 1×1010, 5×1010, 1×1011, 5×1011, 1×1012, 5×1012, 1×1013, 5×1013, 1×1014, or 5×1014 spores/ml, spores/gram, or spores/cm3.

A dryer sheet can be conveniently employed to treat fabrics during a drying process in a dryer. The dryer sheet can be used to treat fabrics that have not been washed or after the fabrics have been washed with a laundry detergent.

### Cleaning Composition Ingredients

Suitable cleaning ingredients include at least one of a surfactant, an enzyme, an enzyme stabilizing system, a detergent builder, a chelating agent, a complexing agent, clay soil removal/anti-redeposition agents, polymeric soil release agents, polymeric dispersing agents, polymeric grease cleaning agents, a dye transfer inhibiting agent, a bleaching agent, a bleach activator, a bleaching catalyst, a fabric conditioner, a clay, a foam booster, an anti-foam, a suds suppressor, an anti-corrosion agent, a soil-suspending agent, a dye, a hueing dye, a bactericide, a tarnish inhibitor, an optical brightener, a perfume, a saturated or unsaturated fatty acid, a calcium cation, a magnesium cation, a visual signaling ingredient, a structurant, a thickener, an anti-caking agent, a starch, sand, a gelling agents, or any combination thereof.

### Additive Composition

The additive compositions of the present disclosure may include additional adjunct ingredients. Such adjuncts may provide additional treatment benefits to the target fabrics, and/or they may act as stabilization or processing aids to the compositions. Suitable adjuncts may include chelant, perfume, structurant, chlorine scavenger, malodor reduction materials, organic solvents, or mixtures thereof.

### EXAMPLES

The following examples demonstrate the improvement in stain removal in a subsequent wash process that results from directly treating a soil with Bacillus spores. The different examples show that the direct treatment of the soil can take place in different ways: directly applied to the textile before staining (example 1), applied to textile during a wash process prior to staining (example 2) or directly to the stain after it has been applied to the fabrics (example 3). However, in all cases the spore treatment results in improved stain removal in the subsequent wash process.

### General Washing Protocol and Stain Removal Analysis Method (Used for all Examples).

All stain swatches were washed identically with 1.7 g/L of a solution of Tide Pods (Procter & Gamble USA) in an experiment involving four external and two internal replicates for each treatment. i.e. 8 washes were completed, 4 containing 2 of the 8 replicates of the spore-treated test products and 4 containing 2 of the 8 replicates of the nil spore control. The washing step was conducted in a 1 L tergotometer containing tap water (Northumbrian Water, 9 gpg (US)) and 5 cm×5 cm knitted cotton ballast (GMT desized knitted cotton, Warwick Equest Ltd, Consett, UK) to make the total load weight to 60 g. The fabrics were washed for 17 minutes at 26° C., 208 rpm, and then rinsed twice for 5 minutes in fresh tap water (15° C.).

Stains were left to dry and evaluated for stain removal using L*a*b* readings taken using a DigiEye (VeriVide Ltd, Leicester, UK) at shutter speed ½, Aperture 8 which was calibrated before use. L*a*b* measurements were taken for unwashed stains, washed stains and unsoiled fabric, and Delta E* calculations made to determine the level of staining for both unwashed stains and washed stains compared to the unsoiled fabric using the following equation where the suffix 1 denotes the values for the unsoiled fabric and the suffix 2 denotes the values for the unwashed or washed stains.

ΔE*_{ab}=\sqrt{(L*₂−L*₁)²+(a*₂−a*₁)²+(b*₂−b*₁)²}

The Stain Removal Index (SRI) is the level of stain removal calculated as a percentage as follows:

SRI=100×(A−B)/A

Where:
A=Delta E* of Unwashed fabric stained region
B=Delta E* of Washed fabric stained region

### Example 1

40 μL of Bacillus spore suspension containing 5×10⁶ CFU/ml Bacillus (prepared using Evozyme® P500 BS7 supplied by Genesis Biosciences, Cardiff, UK) in deionised (DI) water was pipetted onto 8 pieces of 5 cm×5 cm sterilized knitted cotton fabric (GMT desized knitted cotton, Warwick Equest Ltd, Consett, UK) and then left to dry in a biosafety cabinet overnight.

Chocolate milk was then added to these 8 fabric swatches as well as to an additional 8 sterile knitted cotton swatches (control) by pipetting 0.9 ml of Yazoo Chocolate milk (FrieslandCampin) and drying for 48 hours in a biosafety cabinet. The stains were then treated with DI water alone (30% by weight). The 8 replicates of each treatment were placed into separate 350 ml sealed containers with one damp 5 cm×5 cm knitted cotton swatch added (100% DI water by weight), and stored for 72 hours at 21° C. The resulting swatches were washed in accordance with the general washing protocol and stain removal analysis method described above.

### SRI Data:

Chocolate milk

| Pre-treatment step | SRI | Standard Deviation |
|---|---|---|
| Control (nil) | 54.29 | 4.45 |
| Bacillus spores | 86.91 | 2.98 |

### Example 2

8 pieces of knitted cotton fabric (5 cm×5 cm) were washed with 1.7 g/L of a solution of Tide nil enzyme Pods (Procter & Gamble, USA) for 20 minutes on magnetic stirrer plate with stirrer bar (Northumbrian Water, 9 gpg (US), 21° C., 100 rpm) and then rinsed once for 5 minutes in fresh tap water (15° C.). An additional 8 pieces of knitted cotton fabric (test swatches) were washed in the same way (with same detergent) with an additional 40 μL of a 10% Bacillus spore suspension containing 5×10¹⁰ CFU/ml Bacillus (prepared using Evozyme® P500 BS7 supplied by Genesis Biosciences, Cardiff, UK) in DI water added to the wash water. The fabrics were then left to dry in a biosafety cabinet overnight.

Chocolate milk was then added to the 16 pieces of fabric by pipetting 0.9 ml of Yazoo Chocolate milk (FrieslandCampin) onto the fabrics and then drying for 48 hours in a biosafety cabinet. The stains were then treated with DI water alone (30% by weight). The 8 replicates of each treatment were placed into separate 350 ml sealed containers and one damp 5 cm×5 cm knitted cotton swatch added (100% DI water by weight). These were stored for 72 hours at 21° C. The resulting swatches were washed in accordance with the general washing protocol and stain removal analysis method described above.

### SRI Data:

Chocolate milk

| Pre-treatment step | SRI | Standard Deviation |
|---|---|---|
| Control (nil) | 81.19 | 2.22 |
| Bacillus spores | 91.34 | 2.81 |

### Example 3a

Chocolate milk, Mocha and Double Espresso stains (16 of each) were prepared by pipetting 0.9 ml of Yazoo Chocolate (FrieslandCampina), Mocha (Starbucks), and Doubleshot Espresso (Starbucks) onto 5 cm×5 cm knitted cotton fabrics and dried for 48 hours in a drying cabinet.

8 of each stain (test product) were treated with 40 μl of a Bacillus spore suspension containing 5×10⁶ CFU/ml Bacillus (prepared using Evozyme® P500 BS7 supplied by Genesis Biosciences, Cardiff, UK) in deionised (DI) water. Control stains (8 of each) were treated with 40 μl of DI water alone. Additional DI water was added to each stain (30% by weight) and the 8 replicates of each treatment were placed into 350 ml sealed containers (one for all 8 replicates of each treatment) with one damp 5 cm×5 cm knitted cotton swatch (100% DI water by weight), and stored for 72 hours at 21° C. The resulting swatches were washed in accordance with the general washing protocol and stain removal analysis method described above.

### SRI Data:

| | Chocolate milk | | Mocha | | Espresso | |
|---|---|---|---|---|---|---|
| Pre-treatment | | Standard | | Standard | | Standard |
| step | SRI | Deviation | SRI | Deviation | SRI | Deviation |
| Control (nil) | 60.31 | 2.02 | 74.41 | 3.88 | 60.82 | 3.59 |
| Bacillus spores | 80.98 | 0.57 | 88.87 | 0.16 | 85.22 | 0.66 |

### Example 3b

Chocolate milk stains were prepared by pipetting 0.9 ml of Yazoo Chocolate (FrieslandCampina) onto 5 cm×5 cm knitted cotton fabrics and dried for 48 hours in a drying cabinet.

8 of each stain (test products) were treated with 40 μl of a Bacillus spore suspension containing 5×10⁶ CFU/ml Bacillus (prepared using Evozyme® P500 BS7 supplied by Genesis Biosciences, Cardiff, UK; Evogen ON 50X-LQ-(RB) and Evogen GP 50X-LQ-(RB) supplied by Croda International, Goole, UK; and Microvia Pro and Microvia Active supplied by Novozymes, Bagsvord, Denmark) in deionised (DI) water.

Control stains (8 of each) were treated with 40 μl of DI water alone. Additional DI water was added to each stain (30% by weight) and the 8 replicates of each treatment were placed into 350 ml sealed containers (one for all 8 replicates of each treatment) with one damp 5 cm×5 cm knitted cotton swatch (100% DI water by weight), and stored for 72 hours at 21° C. The resulting swatches were washed in accordance with the general washing protocol and stain removal analysis method described above.

### SRI Data:

Chocolate milk

| Pre-treatment step | SRI | Standard Deviation |
|---|---|---|
| Control (nil) | 45.74 | 6.43 |
| Evozyme ® P500 | 84.26 | 1.17 |
| Evogen ON 50X-LQ-(RB) | 80.63 | 0.56 |
| Evogen GP 50X-LQ-(RB) | 77.46 | 1.26 |
| Microvia Pro | 80.48 | 0.8 |
| Microvia Active | 79.45 | 1.24 |

### CONCLUSION

The results from examples 1-3 show that direct treatment of the stain with Bacillus spores leads to improved stain removal in the subsequent wash process regardless of whether the spores are directly applied to the textile before staining (example 1), applied to textile during a wash process prior to staining (example 2) or directly to the stain after it has been applied to the fabrics (example 3). In all cases, the spore treatment showed significantly improved next-wash stain removal compared to the nil spore control. This is illustrated with the significantly higher SRI values for the Bacillus treated fabrics against the control. This difference was highly noticeable to the eye for all three pre-treatments: the control stains contained a high level of brown residue which was almost completely removed from the swatches washed in the test treatment.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of facilitating stain removal from a fabric wherein the stain comprises a carbohydrate and/or fat and a protein comprising the steps of:
a) treating the fabric directly with bacterial spores, wherein the bacterial spores comprise Bacillus spores, prior to a laundry process; and
b) subsequently subjecting the fabric to a laundry process.

2. The method according to claim 1 wherein the Bacillus spores are selected from the group consisting of Bacillus subtilis, Bacillus amyloliquefaciens, Bacillus licheniformis, Bacillus megaterium, Bacillus pumilus, Bacillus cereus, Bacillus thuringiensis, Bacillus mycoides, Bacillus tequilensis, Bacillus vallismortis, Bacillus mojavensis, and mixtures thereof.

3. The method according to claim 1, wherein the Bacillus spores comprise Bacillus amyloliquefaciens, Bacillus licheniformis, Bacillus megaterium, Bacillus pumilus, or a combination thereof.

4. The method according to claim 1, wherein the fabric is treated with the bacterial spores after the fabric has been stained.

5. The method according to claim 1, further comprising storing the treated fabric for about 15 minutes or more before step b).

6. The method according to claim 1, wherein treating the fabric directly with bacterial spores comprises applying the bacterial spores to the fabric from a composition in the form of a spray.

7. The method according to claim 1 wherein the laundry process comprises washing the fabric with a laundry detergent.

8. The method according to claim 7 wherein the laundry detergent comprises enzymes.
